(19) United States
(12) Patent Application Publication
(10) Pub. No.: US 2020/0182225 A1
(43) Pub. Date: Jun. 11, 2020

(54) DETERMINING A WIND SPEED VALUE

(71) Applicant: Siemens Gamesa Renewable Energy A/S, Brande (DK)

(72) Inventor: Torben Nielsen, Sporup (DK)

(21) Appl. No.: 16/623,093

(22) PCT Filed: May 15, 2018
(86) PCT No.: PCT/EP2018/062520

§ 371 Date: Dec. 16, 2019

(30) Foreign Application Priority Data
Jul. 7, 2017 (DE) 10 2017 211 658.7

(51) Int. Cl. F03D 17/00; G01P 5/02; F03D 7/02; F03D 9/25

(52) U.S. Cl. CPC F03D 17/00; F03D 9/25; F03D 7/02; G01P 5/02

(57) ABSTRACT

Provided is a method of determining a value of a wind speed, the method including: measuring a first value of the wind speed using a first wind speed sensor; measuring at least one second value of the wind speed using at least one second wind speed sensor; estimating a third value of the wind speed based on at least one operational parameter of a wind turbine having a rotating rotor at which rotor blades are connected and having a generator coupled to the rotor; determining a fourth value of the wind speed by taking into account the first value and the at least one second value weighted based on the third value.

### CROSS-REFERENCE TO RELATED APPLICATIONS

This application claims priority to PCT Application No. PCT/EP2018/062520, having a filing date of May 15, 2018, which is based on German Application No. 10 2017 211 658.7, having a filing date of Jul. 7, 2017, the entire contents both of which are hereby incorporated by reference.

### FIELD OF TECHNOLOGY

The following relates to a method of determining a value of a wind speed and further relates to an arrangement for determining a value of a wind speed, wherein the arrangement is in particular comprised in a wind turbine.

### BACKGROUND

Wind speed measurements may be very important for controlling a wind turbine and securing maximum performance, for example outputting of electric energy. The wind speed measurement is conventionally used to control the wind turbine during start-up, for stopping in high wind speeds (securely) and various other control features, for example ice detection. Furthermore, the measured wind speed may be used by customers in association with the delivered electric power, to control the wind turbine performance (for example by considering a power curve).

Conventionally, a wind turbine may be equipped with one or more anemometers (or other sensors such as a sonic instrument) on the nacelle which may measure the wind speed. However, due to the rotors and the nacelle structure, the wind field may greatly be disturbed and the point measurements obtained with the nacelle anemometer (or other sensor) are conventionally seldom an accurate estimation of the free wind speed in front of the wind turbine.

The free wind speed (the wind speed in front of the wind turbine which is not disturbed or affected by the structure of the wind turbine) may be estimated using the operational data from the wind turbine. Even if this estimate is conventionally a very accurate estimation of the free wind speed, this estimation however cannot be used for stopping the turbine due to a security policy. Neither would this estimation be accepted by customers as a valid performance indicator. In summary, it may be possible to conventionally obtain a very accurate estimation of the free wind speed. However, due to various circumstances, the free wind speed must be measured by a nacelle anemometer which may not be a reliable source.

Conventionally, a single sensor (e.g. anemometer or sonic instrument) is chosen to be the source for the measured wind speed, as long as it is not faulty.

The measurement is accepted at all times, if the anemometer is not faulty. In this way, information from a second anemometer is disregarded despite the fact that this instrument could provide just as accurate measurements.

Thus, conventionally, wind speed measurement may not be reliable or accurate enough in all circumstances or under all conditions such that there may be a need for a method and arrangement for determining a value of a wind speed which is more accurate and/or more reliable than according to conventional methods and systems.

### SUMMARY

An aspect relates to a method of determining a value of a wind speed, the method comprising: measuring a first value of the wind speed using a first wind speed sensor; measuring at least one second value of the wind speed using at least one second wind speed sensor; estimating a third value of the wind speed based on at least one operational parameter of a wind turbine having a rotating rotor at which rotor blades are connected and having a generator coupled to the rotor; determining a fourth value of the wind speed by taking into account the first value and the at least one second value weighted based on the third value.

The method may be performed by an arrangement for determining a value of a wind speed according to an embodiment of the present invention. The method may for example be performed by a (module of) a controller of the individual wind turbine or by a wind park controller. In particular, the method may determine several values of a wind speed (e.g. values of velocity of the wind derived by different means/methods) corresponding to the wind speed in different directions, for example in three directions being perpendicular to each other. Thus, each value of the wind speed may be characterized by two or three components of the wind speed in different directions. The determined value of the wind speed may relate to the value of the wind speed in front of the wind turbine which may also be referred to as the value of the free wind speed. The free wind speed is the wind speed the wind turbine is subjected to and which is unaffected and undisturbed by the interaction of the air with the wind turbine components.

Conventionally, it may have been difficult to accurately determine the value of the free wind speed, since conventionally anemometers (or other sensor like ultra-sonic sensors) are or may be arranged at the nacelle, i.e. in the direction of the wind behind the rotor blades. In this region behind the rotor blades, the measured wind speed measured by the anemometers may heavily be affected and disturbed due to the rotating blades and the fact that a portion of the wind energy has already been transferred to the rotor blades including the rotor shaft.

Therefore, according to the method according to this embodiment of the present invention, a first value of the wind speed is measured using a first wind speed sensor and at least one second value of the wind speed is measured using at least one second wind speed sensor, wherein in particular, the first wind speed sensor is arranged at a different location than the second wind speed sensor. Nevertheless, both the first wind speed sensor and the at least one second wind speed sensor may be mounted at the nacelle or may be mounted at a tower of the wind turbine or may be mounted at a hub of the rotor blades or on another component of the wind turbine.

The wind turbine may comprise a rotor at which plural rotor blades are connected, a generator which is coupled to the rotor and may further comprise a controller which is adapted to control the wind turbine based on the determined value of the wind speed. Therefore, the fourth value as determined during the method may be used for controlling the wind turbine.

In particular, several second wind speed sensors may be present, such as two, three, four, five, or even more than five second wind speed sensors, each providing an individual second value of the wind speed. The respective first value and second value of the wind speed may be encoded in a particular measurement signal, such as an electric signal and/or an optical signal. For the wind speed sensors, for example a conventional anemometer may be used. In particular, the respective anemometers may be adapted to measure the wind speed in different directions.

The third value of the wind speed is not a measurement value of a wind speed sensor but is estimated from the at least one operational parameter of the wind turbine. The operational parameter may relate to the power output of the wind turbine, to the voltage output, to the current output, to a rotor blade pitch angle and/or a combination of the aforementioned parameters. To determine a “wind speed estimate”, typically use all three, Power, Rotational Speed and Pitch Angle may be used in combination.

In particular, several operational parameters may be combined, for example in a mathematical formula, representing a mathematical/physical model of the wind energy transfer to the rotational energy and power output.

In particular, the third value may be an estimation of the free wind speed (the wind speed in front of the wind turbine which is not disturbed or affected by the structure of the wind turbine) which may be estimated using the operational data from the wind turbine. For example, the estimation of the wind speed may involve simulating the wind turbine power production at given combinations of wind speed, rotor velocity and pitch angles. With a resulting matrix consisting of the relationship between wind speed, rotor velocity, pitch angle and power production, the wind speed may be estimated given the actual operational data.

The first value and the at least one second value are combined in a weighted manner, wherein the weighting is based on the third value, to determine the fourth value of the wind speed. If one of the first value or the second value is determined to be unreliable (e.g. due to a faulty sensor), the respective weighting may even be zero such that the respective value may be disregarded and the fourth value may only be determined from the values of those wind speed sensors which have not been determined to be faulty.

In particular, the fourth value may be different from an arithmetic mean of the first value and the second value. In particular, by weighting the first value and the second value based on the third value, a quality of the individual measurements of the wind speed sensor may be taken into account. Thereby, the estimation of the value of the wind speed may be improved.

In particular, the method may involve estimating the free wind speed based on the operational data. This estimate may then be used to assess the quality of each measurement of each nacelle anemometer and a weighting of all available wind measurements may then be applied based on this quality measure. The proposed approach may secure or may assure that the measured wind speed is based on nacelle anemometers and thus fulfil all requirements to be a valid wind speed measurement source. At the same time, the measured wind speed may be biased towards the free wind speed estimated by the turbine operational data and may thus be more accurate and reliable than conventionally proposed or determined.

Different weightings may be applied to obtain the fourth value from the first value and the second value. Thus, a reliable and accurate value of the wind speed may be determined using the method according to an embodiment of the present invention.

According to an embodiment of the present invention, the fourth value is between the first value and the second value. Thus, the fourth value may for example be a weighted mean of the first value and the second value. However, when the quality of the measurement using the first wind speed sensor is assessed to be higher than the quality of the measurement as performed by the second wind speed sensor, the first value may be weighted higher (in particular higher than 0.5) than the second value. Thus, the fourth value may be different from an arithmetic mean of the first value and the second value which corresponds to a weighting of 0.5 for both values. Thereby, the accuracy and reliability of the determined value of the wind speed may be improved.

According to an embodiment of the present invention, the fourth value is obtained as a sum of the first value multiplied with a first weight and the second value multiplied by a second weight, wherein the first weight and the second weight depend on a first difference between the first value and the third value and on a second difference between the second value and the third value.

The first weight may be different from the second weight, if the quality of the measurements using the different wind speed sensors is different. When the first weight and the second weight depend on a first difference and the second difference, the method may be simplified.

According to an embodiment of the present invention, the first weight and the second weight are different. Herein, the first weight and the second weight may appropriately reflect the quality of the measurement using the respective wind speed sensor.

According to an embodiment of the present invention, the first weight is the larger the smaller the first difference is, wherein the second weight is the larger the smaller the second difference is.

The first weight may in particular be a function of the first difference and may for example be, according to an embodiment, inversely proportional to the first difference. The second weight may be a function of the second difference and may be in particular inversely proportional to the second difference. Thereby, the method may further be improved and simplified.

According to an embodiment of the present invention, the first weight is larger than the second weight, if the first difference is smaller than the second difference, wherein the second weight is larger than the first weight, if the second difference is smaller than the first difference.

If the first difference is smaller than the second difference, the first value is closer to the third value than the second value. In this case, the quality of the measurement performed by the first wind speed sensor is assessed to be higher than the quality of the measurement performed by the second wind speed sensor. For this reason, the first value is weighted higher than the second value. Thereby, the method may be further improved.

According to an embodiment of the present invention, the first value, the second value, the third value and the fourth value are determined, in particular as varying values, over time. The method may involve continuously measuring the first value and the second value and continuously also estimating the third value. Continuously measuring the values of the wind speed may involve taking samples after particular time intervals. The fourth value of the wind speed may continuously be supplied or made available to a wind turbine controller which may control the wind turbine also based on an accurate value of the wind speed. The controller may for example control a blade pitch angle and/or an adjustment of a converter coupled to the generator, may control the wind turbine to start, to stop or to adapt a particular operational mode.

According to an embodiment of the present invention, the first weight and the second weight vary over time, wherein during a first time interval the first weight is larger than the second weight, wherein during a second time interval the second weight is larger than the first weight.

During the first time interval, the real value of the free wind speed may have a first real value and during the second time interval, the real value of the free wind speed may have a second real value different from the first real value. In particular, during the first time interval, the wind speed may have a slightly different direction than during the second time interval. Due to the different directions of the wind speed during the different time intervals, and due to the different positionings of the first wind speed sensor and the second wind speed sensor, the wind speed detected by the first sensor and the second sensor may reflect the real free wind speed to a different degree of certainty or accuracy. Thus, it may be appropriate and necessary to change the weighting in the different time periods or time intervals to accurately determine the value of the wind speed from the two or more wind speed measurements.

According to an embodiment of the present invention, the first wind speed sensor and the second wind speed sensor are installed at the wind turbine, in particular at a nacelle of the wind turbine, and are in particular configured as anemometer. The first wind speed sensor and the second wind speed sensor may be installed at different locations at the nacelle. In other embodiments, the first wind speed sensor is installed at the nacelle and the at least one second wind speed sensor is installed at another component of the nacelle, such as at the tower, at the hub or at any other location. In even other embodiments, none of the first wind speed sensor and the second wind speed sensor is installed at the nacelle but on another component of the wind turbine.

According to an embodiment of the present invention, if the first difference is larger than a threshold, in particular at least over a predetermined time interval, the first value is disregarded and/or the first wind speed sensor is recognized as faulty, wherein, if the second difference is larger than a threshold, in particular at least over a predetermined time interval, the second value is disregarded and/or the second wind speed sensor is recognized as faulty.

If the value of one of the wind speed sensors considerably deviates from the third value determined by estimation from operational parameters, it may indicate that the respective wind speed sensor is faulty. In this situation, the respective value may be disregarded, thereby improving the accuracy and reliability of the method for determining the value of the wind speed.

According to an embodiment of the present invention, the at least one operational parameter comprises at least one of: an output power of the wind turbine; an output voltage of the wind turbine; an output current of the wind turbine; a rotational speed of the rotor of the wind turbine; a pitch angle of a rotor blade of the wind turbine; a setting of a converter connected to a generator of the wind turbine.

A combination of the aforementioned parameters may be used to estimate the value of the wind speed, i.e. determine the third value of the wind speed. The wind turbine controller may have a “wind speed estimator”. This uses the following measurements:
Power
Rotational Speed
Pitch Angle

The wind speed estimator may utilize model data, e.g. stored in a look-up table to identify what is the (rotor-effective) wind speed based on these quantities.

It should be understood that features individually or in any combination, disclosed, explained or provided in the context of a method of determining a value of the wind speed may also be applicable, individually or in any combination, to an arrangement for determining a value of the wind speed according to an embodiment of the present invention and vice versa.

According to an embodiment of the present invention it is provided an arrangement for determining a value of a wind speed, the arrangement comprising: a first wind speed sensor adapted to measure a first value of the wind speed; at least one second wind speed sensor adapted to measure at least one second value of the wind speed; a processor adapted: to estimate a third value of the wind speed based on at least one operational parameter of a wind turbine having a rotating rotor at which rotor blades are connected and having a generator coupled to the rotor, and to determine a fourth value of the wind speed by taking into account the first value and the at least one second value weighted based on the third value.

The arrangement may for example be comprised within a wind turbine, and in particular may be comprised within a controller of a wind turbine. The wind speed sensors may be configured as anemometers. The processor may be present within a conventional wind turbine controller. The processor may be adapted to estimate the third value and to determine the fourth value by loading particular software instructions and executing the software instructions.

According to an embodiment of the present invention it is provided a wind turbine comprising a rotor at which plural rotor blades are connected; a generator coupled to the rotor; an arrangement according to the preceding embodiment; and a controller adapted to control the wind turbine based on the fourth value of the wind speed.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this document.

The aspects defined above and further aspects of embodiments of the present invention are apparent from the examples of embodiment to be described hereinafter and are explained with reference to the examples of embodiment. The embodiments will be described in more detail hereinafter with reference to examples of embodiment but to which the invention is not limited.

### BRIEF DESCRIPTION

Some of the embodiments will be described in detail, with reference to the following figures, wherein like designations denote like members, wherein:

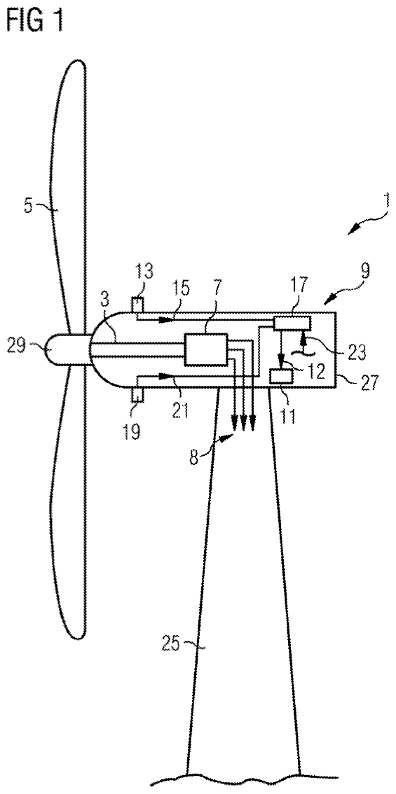

FIG. 1 schematically illustrates a wind turbine according to an embodiment of the present invention including an arrangement for determining a value of a wind speed according to an embodiment of the present invention;

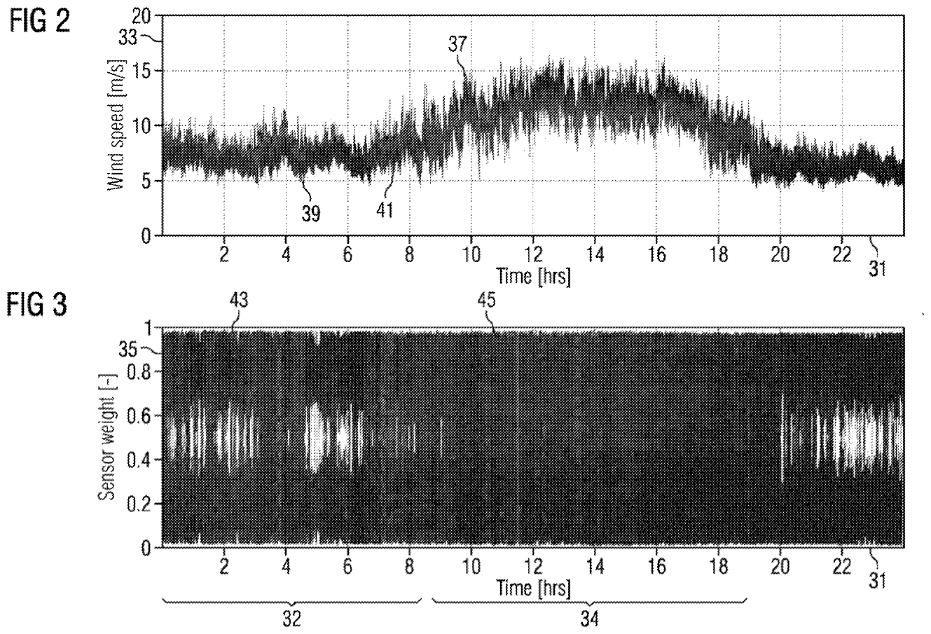

FIG. 2 illustrates a graph of wind speed measurements and an estimation employed in embodiments according to the present invention;

FIG. 3 illustrates a graph depicting a weighting for determining a wind speed employed in embodiments according to the present invention;

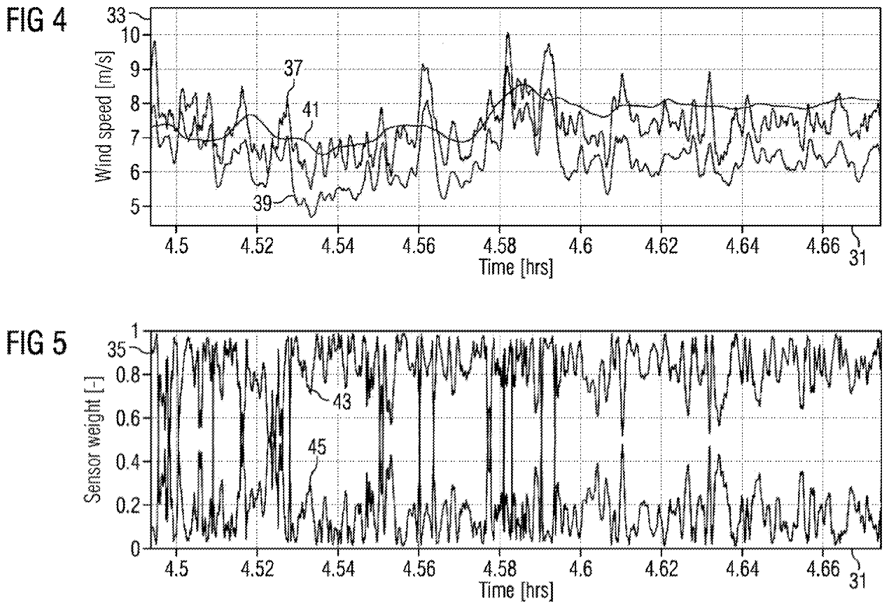

FIG. 4 illustrates a graph of measured and estimated free wind speed as determined according to embodiments of the present invention;

FIG. 5 illustrates a graph indicating a wind speed measurement weighting as employed in embodiments of the present invention;

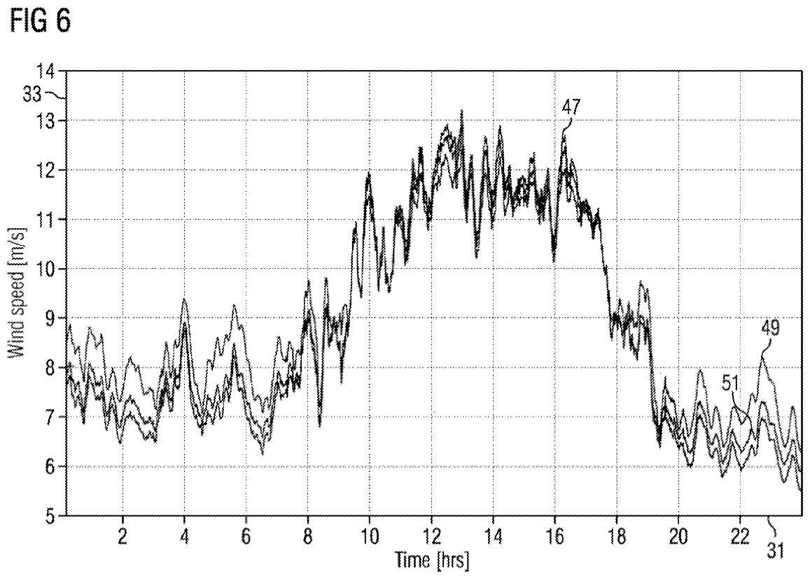

FIG. 6 illustrates a graph of values of wind speed as determined according to embodiments of the present invention; and

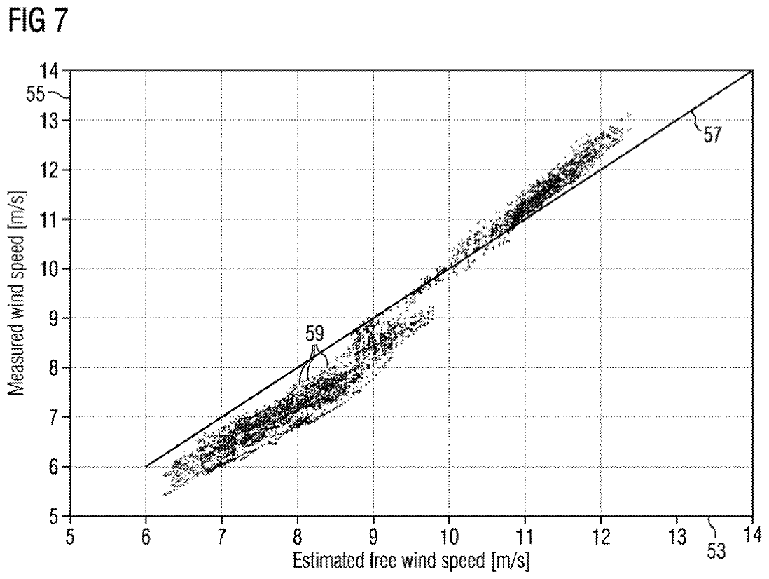

FIG. 7 illustrates a comparison of differently determined wind speeds as considered in embodiments of the present invention.

### DETAILED DESCRIPTION

The illustration in the drawings is in schematic form.

The wind turbine 1 schematically illustrated in FIG. 1 comprises a rotor 3 with a hub 29 at which plural rotor blades 5 are connected. The wind turbine 1 according to an embodiment of the present invention further includes a generator 7 which is coupled to the rotor 3. The generator provides (e.g. via a converter) output power 8. The wind turbine 1 further comprises an arrangement 9 for determining a value of a wind speed according to an embodiment of the present invention and further comprises a controller 11 which is adapted to control the wind turbine 1 based on the determined value 12 of the wind speed.

The arrangement 9 thereby comprises a first wind speed sensor 13 which is adapted to measure a first value of the wind speed which is supplied as a first signal 15 to a processor 17 also included in the arrangement 9. The arrangement 9 further comprises a second wind speed sensor 19 which is adapted to measure at least one second value of a wind speed which is supplied using a second signal 21 to the processor 17. Further, the arrangement 9 comprises the processor 17 which is adapted to estimate a third value of the wind speed based on at least one operational parameter of the wind speed which is represented by an operational signal 23 supplied to the processor 17.

The processor 17 is further adapted to determine a fourth value 12 of the wind speed by taking into account the first value (represented by the signal 15) and the at least one second value (represented by the signal 21) weighted based on the third value representing the estimated wind speed based on the at least one operational parameter (represented by the signal 23). The fourth value 12 is supplied to the controller 11.

The wind turbine further comprises a wind turbine tower 25 on top of which a nacelle 27 is mounted which harbours the rotor 3, the generator 7, the processor 17, and the controller 11. The first and the second wind speed sensors 13 and 19 are attached and arranged at the nacelle 27, in particular at an outer wall of the nacelle 27. The rotor blades 5 are connected to a hub 29 which in turn is coupled to the rotor 3.

The arrangement 9 for determining the value of the wind speed is adapted to carry out a method of determining a value of a wind speed according to an embodiment of the present invention.

Thereby, the free wind speed is estimated based on the operational data and the estimate is then used to assess the quality of each nacelle anemometer measurement, i.e. the measurements of the first and the second wind speed sensor 13, 19, respectively. In particular, a first value of the wind speed as measured by the first wind speed sensor 13 and a second value of a wind speed as measured by the wind speed sensor 19 are weighted based on the quality measure, i.e. based on the third value of the wind speed which is obtained by estimating the wind speed based on the at least one operational parameter. This approach may secure that the measured wind speed is based on nacelle anemometer and thus fulfilling all requirements to a valid wind speed measurement source. At the same time, the measured wind speed may be biased towards the free wind speed as estimated by the turbine operational data and thus may be more accurate and reliable.

Different embodiments of the present invention may employ different kinds of weightings. According to a particular embodiment, the following formulas are used to determine the weights w₁ and w₂:

$${w}_{1} = \frac{{( \frac{{k}_{1} + \vert {v}_{free} - {v}_{2} \vert}{{k}_{1} + \vert {v}_{free} - {v}_{1} \vert} )}^{{k}_{2}}}{{( \frac{{k}_{1} + \vert {v}_{free} - {v}_{2} \vert}{{k}_{1} + \vert {v}_{free} - {v}_{1} \vert} )}^{{k}_{2}} + {( \frac{{k}_{1} + \vert {v}_{free} - {v}_{1} \vert}{{k}_{1} + \vert {v}_{free} - {v}_{2} \vert} )}^{{k}_{2}}}$$

$${w}_{2} = \frac{{( \frac{{k}_{1} + \vert {v}_{free} - {v}_{1} \vert}{{k}_{1} + \vert {v}_{free} - {v}_{2} \vert} )}^{{k}_{2}}}{{( \frac{{k}_{1} + \vert {v}_{free} - {v}_{2} \vert}{{k}_{1} + \vert {v}_{free} - {v}_{1} \vert} )}^{{k}_{2}} + {( \frac{{k}_{1} + \vert {v}_{free} - {v}_{1} \vert}{{k}_{1} + \vert {v}_{free} - {v}_{2} \vert} )}^{{k}_{2}}}$$

Thereby, v₁ represents the first value of the wind speed as measured by the first wind speed sensor 13 and v₂ represents the second value of the wind speed as determined by the at least one second wind speed sensor 19. v_{free} represents the third value of the wind speed (as estimated from the operational parameters of the wind turbine). k₁ and k₂ represent adjustable parameters.

Applying a weighting, such as the above depicted weighting, may provide a flexible and robust weighting of the nacelle measurements which may secure a combined wind speed measurement biased towards the free wind speed estimated by the operational data. This approach may also serve as a continuous fault handling as a faulty sensor (e.g. ice on sensor) may automatically be disregarded.

FIG. 2 and FIG. 3 illustrate an example of a utilization of the method for determining a value of the wind speed according to an embodiment of the present invention. On the abscissas 31, the time is indicated and on the ordinate 33 of the coordinate system of FIG. 2, the wind speed is indicated, while on the ordinate 35 of the coordinate system of FIG. 3, the respective sensor weight is indicated. The first value of the wind speed (obtained by the first wind speed sensor 13) is indicated by a curve 37, the second value of the wind speed (as measured by the second wind speed sensor 19) is indicated by the curve 39 and the third value of the wind speed (as estimated by the processor 17 based on operational wind turbine data) is indicated as a curve 41.

The third value 41 of the wind speed (as estimated from operational parameters of the wind turbine) may be estimated in many different ways. For example, an available power estimator (APE) as used in some conventional wind turbines may be employed. However, other embodiments also support many other methods, for example simple comparison between produced power and power curve or data from a meteorological mass. An idea of embodiments of the invention may be that some sources other than the nacelle anemometer are used to estimate the free wind speed. For example, the processor may access the internet and from there meteorological data regarding pressure distribution, wind speed, precipitation and the like to estimate the wind speed at the location of the wind turbine. How to assess the quality of each nacelle anemometer measurement and to translate that quality measure into a weighting may be done in many different ways. The embodiments are not bound to a specific implementation or formula but rather that some weighting depending on an estimated free wind speed is used.

It should be noticed that the first anemometer measurement in FIG. 2 is closest to the estimated free wind speed at lower wind speeds in a time interval 32, while the second anemometer measurement is closest to the estimated free wind speed at higher wind speeds in time interval 34.

The curve 43 in FIG. 3 indicates the first weight with which the first value of the wind speed is weighted and the curve 45 indicates the second weight, i.e. the weight with which the second value of the wind speed is weighted. It should be noticed that in the time period 32, where the first value of the wind speed is closest to the estimated wind speed, the first weight (curve 43) is higher than the second weight (curve 45), while in a time period 34 in which the second value of the wind speed is closest to the estimated wind speed, the second weight is greater than the first weight.

FIGS. 4 and 5 illustrate a portion of the plots illustrated in FIGS. 2 and 3, respectively, wherein again the abscissas 31 denote the time, while the ordinate 33 denotes the wind speed and the ordinate 35 denotes the respective sensor weight. As can be appreciated from FIG. 5, the first weight 43 and the second weight 45 vary with time. The fourth value of the wind speed is then calculated by determining a weighted mean of the first value 37 and the second value 39 weighted with the first weight 43 and the second weight 45, respectively.

FIG. 6 thereby shows in a coordinate system having an abscissa 31 indicating time and having an ordinate 35 indicating the wind speed as a curve 47 a simple mean, as a curve 49 the third value of the wind speed (as estimated from the operational parameters) and as a curve 51 a fourth value of the wind speed as is determined according to embodiments of the present invention as a weighted mean of the first value 37 and the second value 39 of the wind speed weighted by the first weight 43 and second weight 45. The combined measurement is closer to the estimated free wind speed if embodiments of the invention are used than if a simple mean is used.

FIG. 7 shows a graph having an ordinate 53 indicating the estimated free wind speed and having an ordinate 55 indicating the measured wind speed. The linear curve 57 represents a simple mean of the measurements of the first and the second wind speed sensors 13, 19 the data points 59 indicate the weighted mean as determined according to embodiments of the present invention. The dots 59 are the data points, e.g. 1-second value, 10-second value, or something similar, to which a line is fitted. In particular, FIG. 7 shows that the anemometer measurements are not consistent with the estimated free wind speed. However, using embodiments of the present invention some of that error may be compensated.

According to an embodiment of the present invention, the free wind speed estimation which is obtained from turbine operational is used to assess the quality of each nacelle anemometer measurement. The assessed quality is then used to discriminate the weighting of the nacelle anemometer measurements. Thereby, a number of advantages may be achieved:
A more correct determination of the wind speed for the turbine shutdown in high-speed may be achieved.
A more robust and accurate wind speed measurement may be determined in general.
A continuous compensation of badly calibrated nacelle anemometers may be achieved and a continuous fault handling of faulty nacelle anemometers may be achieved.

Although the present invention has been disclosed in the form of preferred embodiments and variations thereon, it will be understood that numerous additional modifications and variations could be made thereto without departing from the scope of the intention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method of determining a value of a wind speed, the method comprising:
measuring a first value of the wind speed using a first wind speed sensor;
measuring at least one second value of the wind speed using at least one second wind speed sensor;
estimating a third value of the wind speed based on at least one operational parameter of a wind turbine having a rotating rotor at which rotor blades are connected and having a generator coupled to the rotor;
determining a fourth value of the wind speed by taking into account the first value and the at least one second value weighted based on the third value.

2. The method according to claim 1, wherein the fourth value is determined to be between the first value.

3. The method according to claim 1, wherein the fourth value is obtained as a sum of the first value multiplied with a first weight and the second value multiplied by a second weight, further wherein the first weight and the second weight depend on a first difference between the first value and the third value and on a second difference between the second value and the third value.

4. The method according to claim 3, wherein the first weight and the second weight are different.

5. The method according to claim 3, wherein the first weight is the larger the smaller the first difference is, further wherein the second weight is the larger the smaller the second difference is.

6. The method according to claim 3, wherein the first weight is larger than the second weight, if the first difference is smaller than the second difference, wherein the second weight is larger than the first weight, if the second difference is smaller than the first difference.

7. The method according to claim 1, wherein the first value, the second value, the third value and the fourth value are determined as varying values, over time.

8. The method according to claim 1, wherein the first weight and the second weight vary over time, further wherein during a first time interval the first weight is larger than the second weight, and during a second time interval the second weight is larger than the first weight.

9. The method according to claim 1, wherein the first wind speed sensor and the at least one second wind speed sensor are installed at a nacelle of the wind turbine and are configured as anemometer.

10. The method according to claim 1, wherein, if the first difference is larger than a threshold, at least over a predetermined time interval, the first value is disregarded and/or the first wind speed sensor is recognized as faulty, further wherein, if the second difference is larger than a threshold at least over a predetermined time interval, the second value is disregarded and/or the second wind speed sensor is recognized as faulty.

11. The method according to claim 1, wherein the at least one operational parameter comprises at least one of:
an output power of the wind turbine;
an output voltage of the wind turbine;
an output current of the wind turbine;
a rotational speed of the rotor of the wind turbine;
a pitch angle of a rotor blade of the wind turbine;
a setting of a converter connected to a generator of the wind turbine;

12. An arrangement for determining a value of a wind speed, the arrangement comprising:
a first wind speed sensor configured to measure a first value of the wind speed;
at least one second wind speed sensor configured to measure at least one second value of the wind speed;
a processor configured to:
estimate a third value of the wind speed based on at least one operational parameter of a wind turbine having a rotating rotor at which rotor blades are connected and having a generator coupled to the rotor, and
determine a fourth value of the wind speed by taking into account the first value and the at least one second value weighted based on the third value.

13. A wind turbine comprising:
a rotor at which plural rotor blades are connected;
a generator coupled to the rotor;
the arrangement according to claim 12; and
a controller configured to control the wind turbine based on the fourth value of the wind speed.
